(19) United States
(12) Patent Application Publication
(10) Pub. No.: US 2008/0313939 A1
(43) Pub. Date: Dec. 25, 2008

(54) Identification of personnel attending surgery or medical related procedure

(76) Inventor: William D. Ardill, San Diego, CA (US)

Correspondence Address: WILLIAM W. HAEFLIGER, 201 S. LAKE AVE, SUITE 512, PASADENA, CA, 91101, US

(21) Appl. No.: 11/821,484

(22) Filed: Jun. 25, 2007

(51) Int. Cl. G09F 3/00

(52) U.S. Cl. 40/329

(57) ABSTRACT

The method of providing for rapid identification of personnel attending surgery for enhancing surgical or surgical related procedure efficiency, that includes providing a surgical related item selected from one or more of the following: a disposable lightweight face mask, a disposable lightweight cap, or a disposable lightweight gown; the provision of that item including fabricating a label integrated into the item, to face outwardly; at or close to the time of surgery writing the item wearer's identification on the label; the above steps effected to allow persons in the surgical procedure area to instantly visually observe that identification, during surgery, to enable the wearer's quick summoned assistance to the surgeon, in aid of such procedure.

### BACKGROUND OF THE INVENTION

This invention relates generally to rapidly aiding surgeon identification of personnel such as nurses and aids in operating rooms or areas, and more particularly concerns method of said quick, identification where such personnel are wearing masks, caps, or gowns and are difficult to quickly identify as for summoning or other needs.

Problems with rapid personnel identification in such environments can lead to unwanted delays in required medical or surgical procedures. There is critical need for methods to prevent or obviate such delays, as during surgical procedures. There is also need to provide a clear record of those in attendance during surgery.

### SUMMARY OF THE INVENTION

It is a major object of the invention to provide methods and means for solving the described problems in a simple, and effective manner. Basically, the method of the invention, for enhancing surgical efficiency and safety, includes the steps:

a) providing a surgical item selected from one or more of the following:
i) a disposable, lightweight face mask,
ii) a disposable lightweight cap,
iii) a disposable lightweight gown,

b) said provision of said item including fabricating a label integrated into said item, to face outwardly,

c) at or close to the time of surgery, writing the item wearer's identification on said label,

d) said b) and c) steps effected to allow the surgeon or his assistant to instantly visually observe that identification, during surgery, to enable the wearer's quick summoned assistance to the surgeon.

As will be seen, the above step b) of the method typically includes fabricating the label to peripherally join to disposable fabric of said item, for example to prevent the label from falling into the surgical sterile field. The label is preferably at least two inches long, and at least one inch wide, for legibility of a written name observed at a distance, when worn by a person standing 1 or several paces from a surgeon, during surgery. The label may consist of a material which differs from the flexible disposable material of said item, and which presents a smooth writing surface.

The method provides for ease of disposition of the wearable item and label, after surgery, as by removing the label from the item, disposition of the wearable item which may be soiled by fluid, and for preservation of the removed label to preserve the information written on the label as for example as a permanent record of those in attendance at the surgery. The label may be cut free from the garment, cap or mask on which it is flatly and peripherally integrated. Such integration in the first instance may enable label withstanding sterilization of the garment, cap or mask, and requires no last-minute assembly to the worn item, as in un-sterilized manner or conditions.

A further object of the invention comprises provision of such a label for integration on a surgical cap, garment or mask, or on more than one of them, as referred to.

Yet another object includes provision of the said method, and wherein the defined labels are provided on at least two, and optionally all three of the items (garment, mask and cap), worn by each of the referenced personnel in attendance at surgery, and whereby critical information may be written on at least two of the labels as worn by each person, and written quickly at the time of surgery.

An additional object includes providing for identification of personnel attending a medical related procedure in an environment where such personnel wear one or more of the following items:
i) a disposable, lightweight face mask,
ii) a disposable lightweight cap,
iii) a disposable lightweight gown, that includes:

a) providing said item including integrating a label into or onto said item, to face outwardly,

b) writing the item wearer's identification on the label to be observed at the time of said procedure,

c) said a) and b) steps effected to allow persons attending said procedure to instantly visually observe that identification, to enable the wearer's quick summoned assistance.

These and other objects and advantages of the invention, as well as the details of an illustrative embodiment, will be more fully understood from the following specification and drawings, in which:

### DRAWING DESCRIPTION

FIG. 1 shows labels as referred to integrated on or with a surgical face mask, and also with a cap;

FIG. 2 shows a label as referred to, as integrated on or with a bouffant surgical cap;

FIG. 3 shows a label as referred to and as integrated on or with a surgical gown or garment;

FIG. 4 is an enlarged plan view showing a label peripherally integrated with a fabric, such as a gown, mask or cap fabric;

FIG. 5 is a section taken on lines 5-5 of FIG. 4;

FIG. 6 is a view like FIG. 5, but showing another method of label fabric integration;

FIG. 7 is a functional block diagram showing method steps.

### DETAILED DESCRIPTION

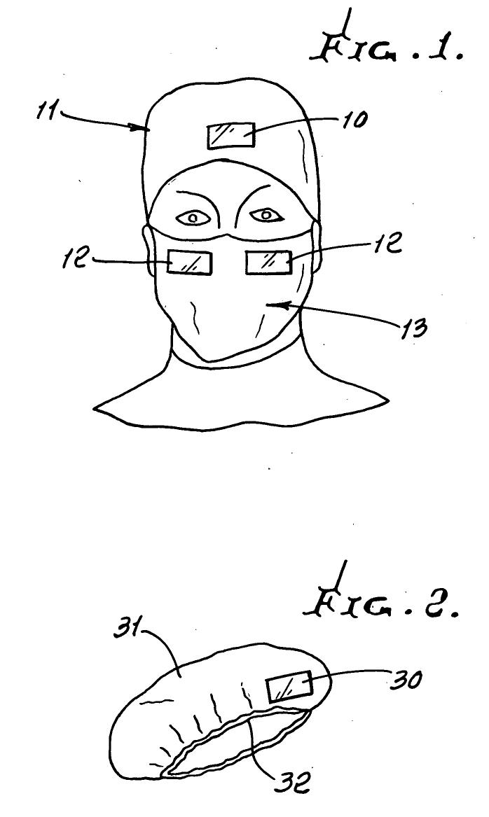

Referring first to FIG. 1, it shows a label 10 integrated onto a surgical, or surgical type cap item 11, in accordance with the steps of the method illustrated in functional block form in FIG. 7. The label faces forwardly to be readily viewed by a surgeon or other person needing quick assistance during a medical related procedure (surgery, hospital emergency room procedure, cardiac catheterization, x-ray department procedure, etc.). The cap typically consists of lightweight fabric or material, to be disposed of, following the surgery or procedure. The label may also then be disposed of, or may be removed or severed from the cap, for preservation, record storage, etc.

FIG. 1 also shows two such labels 12 integrated onto a surgical or surgical related type disposable lightweight face mask 13 likewise in accordance with the step of the FIG. 7 depicted method. The labels 12 face forwardly to be readily viewed by a surgeon or other person needing quick assistance as during surgery or other medical related procedure. In FIG. 2, a label 30 is integrated onto a bouffant cap 31, above elastic 32 level.

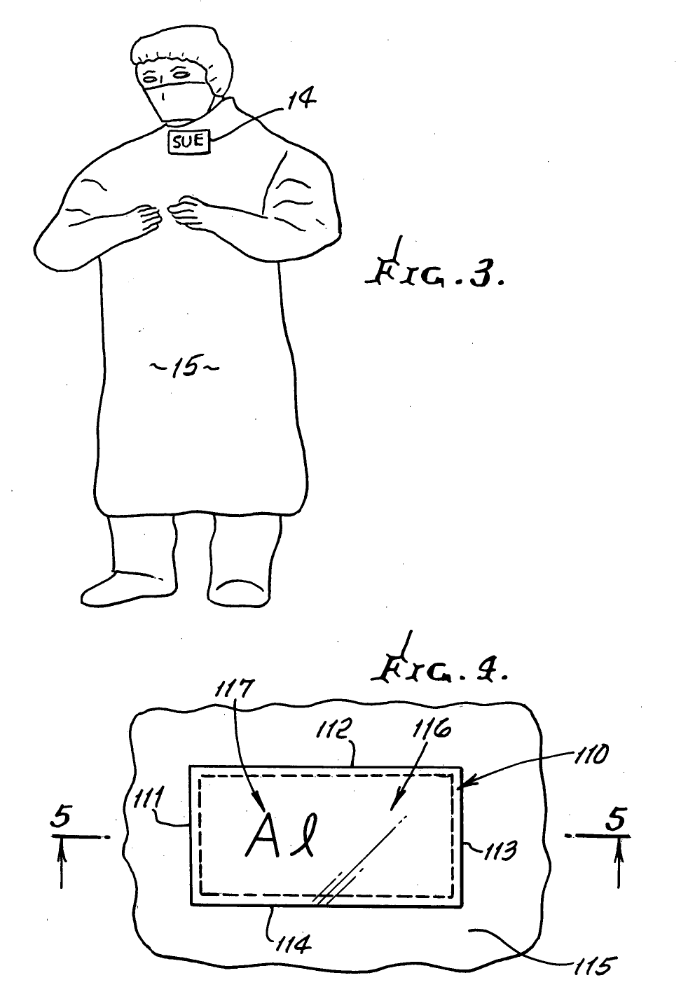

FIG. 3 shows a label 14 integrated onto a surgical or related type disposable lightweight gown 15, likewise in accordance with the steps of the FIG. 7 depicted method. Label 14 is on the front of the gown, to face forwardly near the wearer's face, for ease of viewing.

Labels 12 and 14 may be disposed of with the mask and gown, or removed, for preservation. The labels 10, 12, and 14 may be configured differently, or colored, to designate use on the cap, mask or gown, so that after removal from these items the mode of use of the labels on said item is preserved after label storage, or is indicated during the procedure (for example, nurse 1, nurse 2, assistant 1, specialist 1, specialist 2 etc.).

Referring to FIG. 7, a label is fabricated or supplied at 100, and a disposable, lightweight sterile fabric item such as a face mask, cap or gown is supplied at 101. The label is applied to the item to be integral therewith, as at 102; and the wearer's identification and/or other information is written on the label, at 103. The label, or label and writing may be sterilized, as at 103a, for enhanced safety. Such writing preferably occurs at or close to the time of surgery (or other medical related procedure, as referred to above) such time or procedure indicated at 104. Rapid summoning of the person wearing the label, after visual identification, is indicated at 105, as to provide rapid assistance, as may be critical during surgery. Step 106 indicates removal of the label from the worn item, and disposal of the latter occurs at 107. The removed labels may then be stored at 108, for future use, as in identifying those that were in attendance at the surgery (or other medical related procedure).

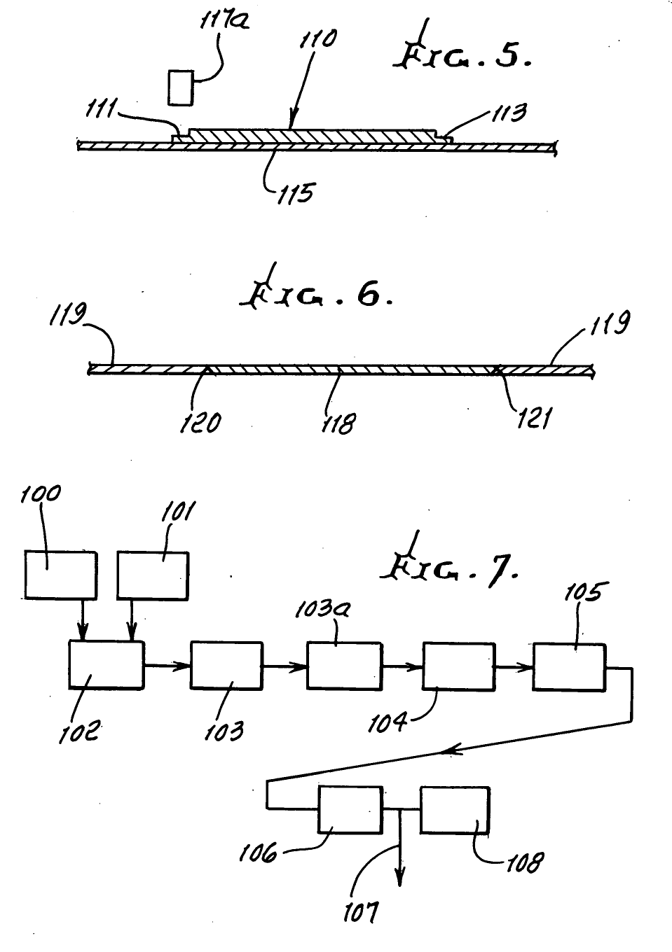

FIG. 4 shows a thin label 110 peripherally, i.e. edgewise integrated, as at edges 111-114, with the thin fabric 115 of a face mask, cap or gown, leaving intermediate flat area 116 available for writing on the label, as for example is indicated at 117. The label is typically about two inches long, and at least about one inch wide, for maximum visibility and minimum interference with use of the cap, mask or gown. FIG. 5 shows, in section, the label edges 111 and 113 attached as by fusing or stitching, to the fabric 115, or sealing (to prevent bacterial entrance between label and fabric). A heat fusion tool is shown at 117a. FIG. 6 shows a label 118 extending in generally the same plane as that of item 119 (cap, mask or gown), with edge attachment 120 and 121.

Features and benefits of the invention are listed as follows:

| Feature | Benefit |
|---|---|
| Surgical Mask | provided with an area for |
| | handwriting; |
| | allows display of names for |
| | purposes of wearer |
| | identification; |
| | allows for a higher level of |
| | medical care. |
| Writing Areas | provided on front and sides of |
| | mask; |
| | does not interfere with |
| | breathing; |
| | does not interfere with germ |
| | reduction ability; |
| | can be written upon using |
| | standard pen; |
| | labels differently configured, |
| | or colored to designate one or |
| | more of the following: |
| | x₁) mode of label use on said |
| | item, |
| | x₂) function or status of |
| | wearer as related to the |
| | procedure, |
| | for coding; |
| | information related to |
| | surgical procedure can also |
| | be written on labels, to |
| | relate personnel in attendance |
| | to procedure performed. |
| Multiple | ideal for surgery areas where |
| Applications/Uses | eyes only of personnel are |
| | showing; |
| | prevents label from falling |
| | into surgically sterile areas |
| | or fields; |
| | ideal for emergency/triage |
| | situations; |
| | can also aid in identification |
| | of user's technical ability |
| | during emergency situations; |
| | can be adapted to other fields |
| | in which masks are worn. |
| Label material | readily available materials, |
| construction | strong and durable providing |
| | smooth surface or surfaces for |
| | writing; |
| | ease of manufacture; |
| | cost-effective design; |
| | label may be substantially |
| | stiffer than the fabric of the |
| | cap, mask or gown, to resist |
| | wrinkling and remain |
| | substantially planar, so |
| | writing on label does not |
| | wrinkle, to be clearly visible |
| | and legible despite fabric |
| | wrinkling near label. |

I claim:

1. The method of providing for rapid identification of personnel attending surgery for enhancing surgical efficiency, that includes:
a) providing a surgical item selected from one or more of the following:
i) a disposable, lightweight face mask,
ii) a disposable lightweight cap,
iii) a disposable lightweight gown,
b) said provision of said item including fabricating a label integrated into said item, to face outwardly,
c) at or close to the time of surgery, writing the item wearer's identification on said label,
d) said b) and c) steps effected to allow persons in the room to instantly visually observe that identification, during surgery, to enable the wearer's quick summoned assistance to the surgeon, or other person.

2. The method of claim 1 wherein said b) step includes fabricating the label to peripherally join to disposable fabric of said item, to prevent the label from falling into the surgical sterile field.

3. The method of claim 1 wherein said label is generally rectangular, and has a length of at least two inches and width of at least one inch.

4. The method of claim 1 wherein said label consists of material which presents a smooth writing surface.

5. The method of claim 1 including disposing of said labeled item, and label, after surgery.

6. The method of claim 1 including removing the label from said item, after surgery, disposing of said item, and preserving the removed label.

7. The method of claim 1 including also writing on the label an identification of the surgery being performed.

8. The method of claim 7 including removing the label from said item, after surgery, disposing of said item, and preserving the removed label as direct evidence of attendance at said surgery.

9. The method of claim 1 wherein said step b) is carried out for each of multiple personnel attending the surgery.

10. The method of claim 1 including providing for sterilization of the item and integrated label, and writing, prior to item use during surgery.

11. The labeled items produced by the method of claim 1.

12. The method of claim 1, wherein the defined labels are provided on at least two of the items i), ii) and iii) worn by each of the referenced personnel, whereby critical information may be written on at least two of said worn labels.

13. The method of claim 1, wherein the defined labels are provided on all three of the items i), ii), and iii), worn by each of the referenced personnel, whereby critical information may be written on at least three of the labels worn by each said person.

14. The method of claim 1 including providing multiple said labels to face outwardly and frontwardly on one or more of the mask, garment and cap, as defined.

15. The method of providing for rapid identification of personnel attending a medical related procedure in an environment where such personnal wear one or more of the following items:
i) a disposable, lightweight face mask,
ii) a disposable lightweight cap,
iii) a disposable lightweight gown, that includes:
a) providing said item including integrating a label into or onto said item, to face outwardly,
b) writing the item wearer's identification on the label to be observed at the time of said procedure,
c) said a) and b) steps effected to allow persons attending said procedure to instantly visually observe that identification, to enable the wearer's quick summoned assistance.

16. The method of claim 15 including fabricating the label to have edge portions to be joined to disposable fabric of said item, the label further characterized as resisting wrinkling.

17. The method of claim 15 including removing the label from said item, upon completion of said procedure, disposing of said item, and preserving the removed label.

18. The method of claim 15 wherein the labels are differently configured, or colored, to designate one or more of the following:
x₁) mode of label use on said item,
x₂) function or status of wearer as related to the procedure.
